(19) United States
(12) Patent Application Publication
(10) Pub. No.: US 2014/0191511 A1
(43) Pub. Date: Jul. 10, 2014

(54) System for Generating Electricity

(71) Applicant: Flying By Design, Inc., St. Petersburg, FL (US)

(72) Inventors: William J. Markie, St. Petersburg, FL (US); Michael Markie, St. Petersburg, FL (US)

(73) Assignee: FLYING BY DESIGN, INC., St. Petersburg, FL (US)

(21) Appl. No.: 14/150,495

(22) Filed: Jan. 8, 2014

Related U.S. Application Data
(60) Provisional application No. 61/848,675, filed on Jan. 9, 2013.
(60) Provisional application No. 61/851,000, filed on Feb. 27, 2013.

(51) Int. Cl. F03B 13/10

(52) U.S. Cl. CPC F03B 13/10
USPC 290/54

(57) ABSTRACT

Disclosed is a system for storing and recovering energy, the system comprising an energy capturing device, a storage vessel operably linked to the energy capturing device, the storage vessel adapted to receive and store energy captured by the energy capturing device, and an energy recovery device adapted to receive the stored energy from the storage vessel, the energy recovery device operable to convert the stored energy to electrical energy. The energy recovery device is in electrical communication with an existing electrical infrastructure, whereby the electrical energy is delivered to a population.

### RELATED APPLICATION DATA

This application claims priority to co-pending Provisional Application Ser. No. 61/848,675 filed on Jan. 9, 2013 and entitled “Two-way Pull Bar Assembly System” and co-pending Provisional Application Ser. No. 61/851,000 filed on Feb. 27, 2013 and entitled “Fluid Turbine Energy Recovery System.” The content of these applications is fully incorporated by reference herein for all purposes.

### TECHNICAL FIELD

This disclosure relates to an energy recovery system, and more particularly to an energy recovery system that is used with various fluids of different densities to recover energy and generate electrical and/or mechanical energy using a turbine system.

### BACKGROUND OF THE INVENTION

Energy is captured and converted from one form to another in a multitude of manners. However, some of the cleanest and most abundant means of converting energy to electrical energy, such as through the use of windmill turbines, creates an enormous challenge in delivering that electrical energy when the demand for that electrical energy is needed the most. For example, the most abundant time of electrical energy production from windmills comes when the seasons are changing, particularly in the spring and in the fall when horizontal wind speeds are greatest. Once electrical energy is created, it must be transported to the power grid for consumption. However, it is during these periods of the year when the energy demand is at its lowest. Conversely, in the middle of summer when the horizontal wind speeds are near their lowest of the year, the energy demand is at its greatest. This requires other electrical energy power sources, such as coal and nuclear power, to be leveraged to supplement the lack of power generated by windmills. A common complaint of wind energy is that the wind is variable and is often unavailable when power demands are greatest.

In some circumstances, it is impractical to store electrical energy created by windmills in large batteries for use when power demand rises in the summer months. Presently, nearly all energy that is supplied by any power generation source is plugged into a power grid and delivered according to the power needs of commercial and residential power consumers. It is extremely inefficient to call upon supplemental sources of energy required by coal and nuclear power suppliers just during the summer months when demand is the greatest as those sources of power are utilized at a fraction of their potential during the spring, winter and fall months.

Furthermore, there are instances when energy is being exhausted and potential electrical energy is being wasted. Some examples include water circulation and aeration activities that are used to improve the quality of water or effect desalinization. Other instances include activities to provide nutrients, filtration and oxygenation to fish farms. Waste water treatment also requires the movement of water which results in an unutilized source of potential energy. Still yet another example might include the compression and expansion of gas for heating and cooling. Capturing these sources of energy and converting these sources of energy into electrical power can lessen the demand on the power grid to supply power to commercial and residential consumers.

Thus, there is a need for an energy recovery system that produces a negligible or even positive environmental impact while producing power. There is also a need to store energy created by clean energy sources during times when electrical power demand is low so that the energy might be supplied when electrical power demands are high. Furthermore, there is a need to capture energy being used and lost to the surrounding environment in instances where electrical energy could be produced as a by-product.

### SUMMARY OF THE INVENTION

The system described herein has several important advantages. For example, one advantage of the present invention includes generating electricity through the use of counter-current flows.

Another advantage of the system disclosed herein includes the storage of energy for later use when needed.

Yet another advantage of the present disclosure includes the use of first and second fluids having different densities to create a counter-current flow for generating electricity.

Even yet another advantage of the present invention includes providing an elongated housing that accommodates a rotor assembly, wherein the rotor assembly rotates in response to a counter-current flow, thereby providing a force sufficient for generating electricity.

A further advantage of the present disclosure includes providing a system for generating electricity by capturing energy released from existing fluid systems.

Still yet another advantage of the present disclosure includes providing a clean source of electrical and/or mechanical energy.

### BRIEF DESCRIPTION OF THE DRAWINGS

For a more complete understanding of the present disclosure and its advantages, reference is now made to the following descriptions, taken in conjunction with the accompanying drawings, in which:

FIG. 1 is a cross-sectional side view of the energy recovery system in a closed system.

FIG. 2 is a cross-sectional side view an optional embodiment of the energy recovery system in a closed system illustrating an exterior turbine capturing flow.

FIG. 3 is a cross-sectional side view of the energy recovery system in an open system.

FIG. 4 is a diagram of the energy recovery system in use with a fluid storage system and power grid.

FIG. 5 is a cross-sectional side view of an alternative embodiment of the energy recovery system of the present disclosure.

FIG. 6 is a cross-sectional top view viewed from line 6-6 of FIG. 5.

Similar reference numerals refer to similar parts throughout the several views of the drawings.

PARTS LIST

| | |
|---|---|
| 10 | energy recovery system |
| 14 | holding tank |
| 15 | side port of holding tank |
| 16 | elongated housing |
| 17 | top opening of holding tank |
| 22 | primary rotor assembly |
| 24 | turbine |
| 26 | shaft |
| 28 | blade |
| 30 | first fluid |
| 32 | second fluid |
| 36 | suspension cap |
| 38 | generator |
| 40 | fluid introduction line |
| 42 | dispersant nozzle |
| 44 | secondary rotor assembly |
| 46 | storage vessel |
| 48 | body of liquid fluid |
| 50 | windmill |
| 52 | electrical infrastructure |
| 54 | stator |
| 56 | bracket |
| 62 | electrical power system |
| 66 | air compressor |
| 68 | flotation device |

### DETAILED DESCRIPTION OF EMBODIMENTS

The present invention relates to an energy recovery system that utilizes a fluid flow created by mixing fluids of varying densities to drive the rotation of a turbine, thereby generating electrical energy. The various components of the present invention, and the manner in which they interrelate, are described in greater detail hereinafter.

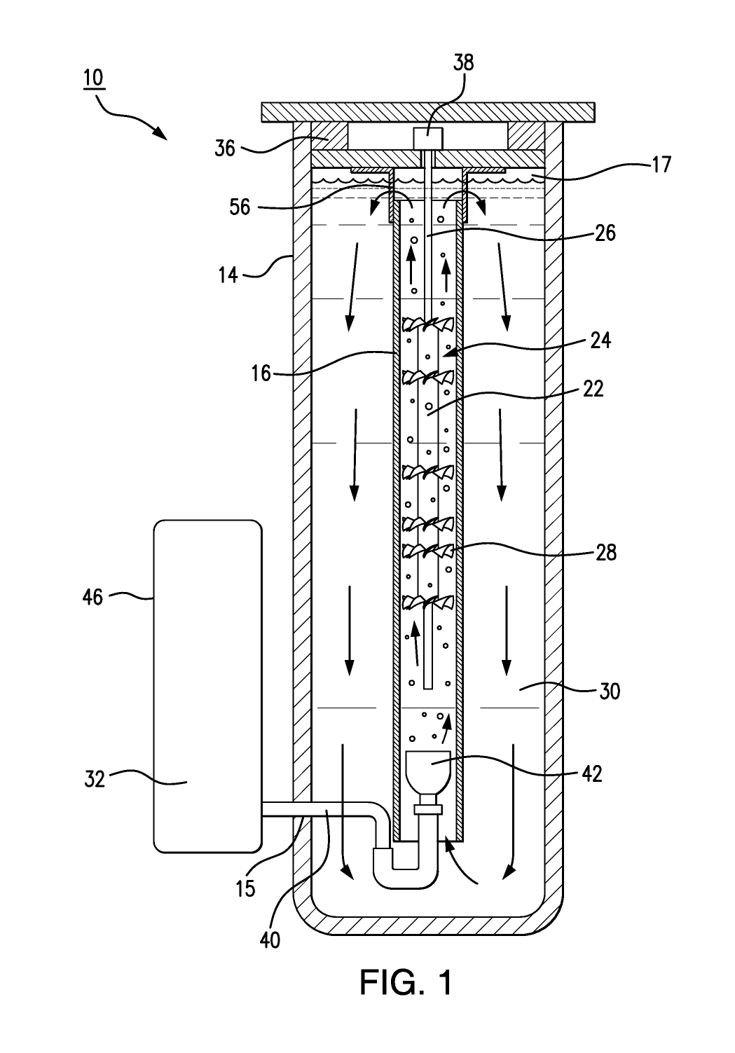

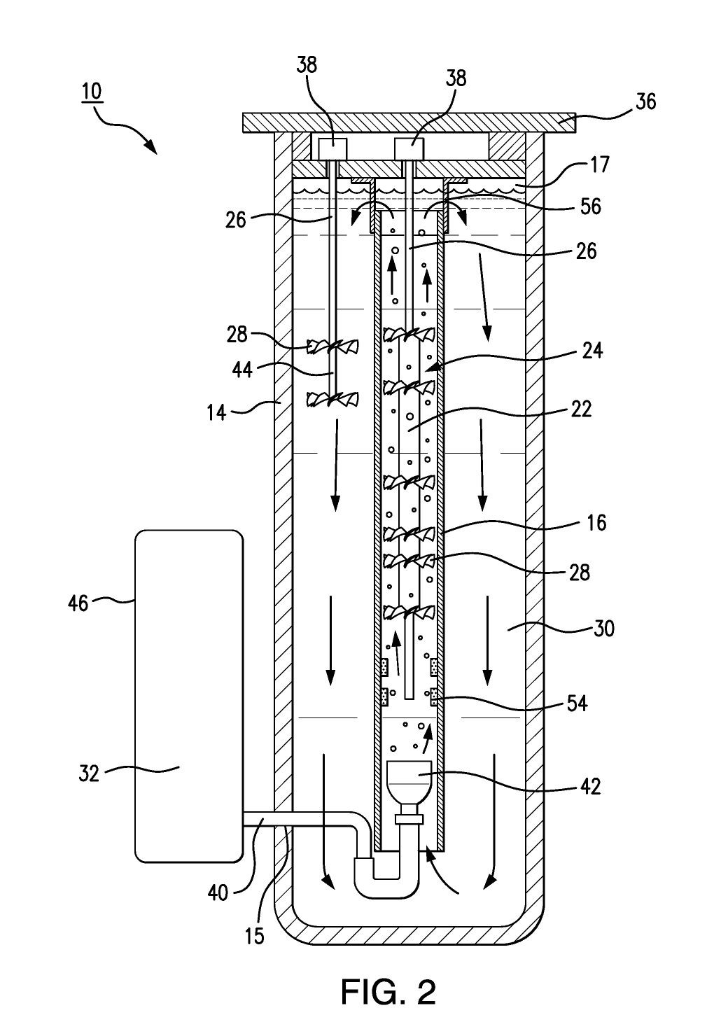

Initially with reference to FIGS. 1 and 2, one embodiment of the present invention includes a system 10 for generating electricity, the system 10 comprising a first fluid 30 having a first density and a second fluid 32 having a second density, the first density being greater than the second density. As will be discussed in greater detail below, a preferred embodiment includes water as the first fluid and compressed air as the second fluid. Alternatively, however, any number of different fluids may be utilized, so long as the first fluid is of a different density than the second fluid. For example, the first fluid may be water and the second fluid may be any one of a less dense oil.

In one embodiment, the system 10 includes a holding tank 14 for receiving the first fluid 30, the holding tank 14 being generally cylindrical and including a lower opening or side port 15 and a top opening 17. Prior to use, the first fluid 30 is positioned in the holding tank.

Also provided is a cylindrical elongate housing 16 having an interior surface, an exterior surface, and first and second open ends, the elongate housing 16 disposed within and in fluid communication with the holding tank 14. Thus, the positioning of the first fluid in the holding tank also results in a positioning of the first fluid in an interior area of the elongate housing. In one preferred embodiment, the elongate housing 16 is situated in a substantially upright or vertical direction for the most efficient use. However, other angles of situating the elongated housing 16 might also be used to accomplish an energy recovery action by the energy recovery system 10. Thus, the elongate housing 16 is adapted for channeling the less dense second fluid 32 upwardly through the more dense first fluid 30. An alternative embodiment of the present invention also includes at least one stator 54 integral with the interior surface of the elongate housing 16 for increasing a flow rate therethrough (see FIG. 2).

As will be discussed in greater detail hereinafter, the elongate housing 16 channels fluid flow into a rotor assembly 22 of a turbine 24. Thus, the elongate housing 16 serves to accommodate a shaft 26 and at least one blade 28 of the rotor assembly 22 and therefore, must have a wide enough cross-sectional area to support movement of the at least one blade 28.

The elongate housing 16 is preferably made of a hard and durable material and should be corrosion resistant to a first fluid 30 or a second fluid 32 that the elongated housing 16 might come into contact with. This hard and durable material may be a metal such as copper, aluminum, stainless steel, or iron. An optional hard and durable material may be a polymer or ceramic.

The elongate housing 16 may optionally be provided in various shapes, including but not limited to conical, cylindrical, and rectangular. The embodiment in FIG. 1 illustrates a cylindrical shape. In an enclosed system as shown in FIG. 1, the elongate housing 16 is submerged in the first fluid 30 such that displaced fluid, or flow, might move over a top end of the elongated housing 16. Thus, the first fluid occupies the interiors of both the holding tank 14 and the elongate housing 16. Complete submersion is not required as partial submersion can be employed to accomplish substantially the same effect, especially when an exhaust vent is placed on or proximate to an upper area of the elongate housing 16. As depicted in FIG. 1, the elongate housing 16 is preferably open at the top and bottom ends. However, other designs might be employed to assist in keeping impurities away from the rotor assembly 22 such as placing a filter, mesh, or other porous covering over the top end and/or the bottom end of the elongate housing 16.

With continued reference to FIG. 2, another embodiment of the present invention includes a primary 22 and at least one secondary 44 rotor assembly, the primary rotor assembly 22 rotatably secured within the elongate housing 16, the at least one secondary rotor assembly 44 rotatably secured within the holding tank 16, each rotor assembly further comprising a turbine 24 including a shaft 26 and at least one blade 28. As the second fluid 32 travels upwards through the first fluid 30, a flow is created sufficient to drive the rotation of the primary rotor assembly 22.

With continued reference to FIGS. 1 and 2, one embodiment of the present invention includes a suspension cap 36 for sealing the top opening 17 of the holding tank 16. The suspension cap 36 is fixedly secured to the elongate housing 16 by at least one bracket 56, thereby suspending the elongate housing 16 within the holding tank 14.

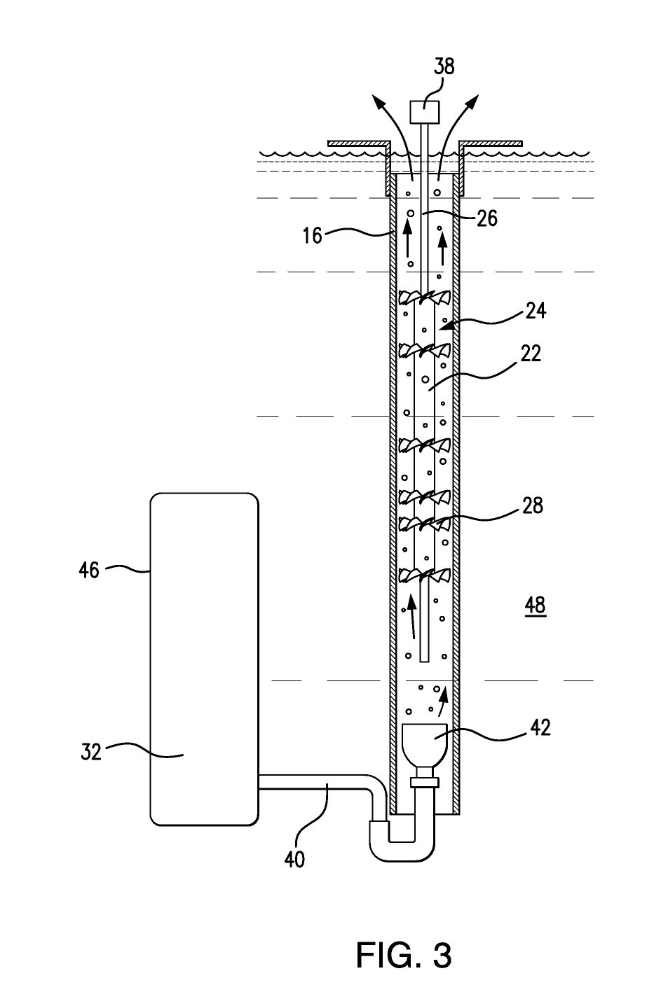

The suspension cap 36 in the embodiment shown in FIGS. 1 and 2 runs the width or diameter of the holding tank 14 such that the turbine 24 and elongated housing 16 might be easily suspended in the holding tank 14. This embodiment of the suspension cap 36 makes access to the energy recovery system 10 easier for maintenance and repair, as removal of the suspension cap 36 lifts the elongate housing 16 out of the holding tank 14. However, in an open system such as the one shown in FIG. 3, a flotation device 68, anchoring device, platform or other buoying system could be used to accommodate the same suspension requirements if the characteristics of the generator 38 mandate the suspension.

In one embodiment, at least one generator 38 integral with or supported by the suspension cap 36 is provided, the at least one generator 38 operably connected to the primary 22 and at least one secondary 44 rotor assemblies. One of ordinary skill in the art will appreciate that the generator 38 may also be positioned independent of the suspension cap 36. The at least one generator 38 is kept out of the first fluid 30 in the embodiment shown in FIG. 1. However, if the generator 38 was insulated from the first fluid 30, the generator 38 may optionally be partially to completely submerged in the first fluid 30. The generator 38 receives mechanical energy from the rotor assembly 22 when the shaft 26 spins and converts the mechanical energy to electrical energy.

The second fluid 32 is introduced into the elongate housing 16 using a fluid introduction line 40 including a dispersant nozzle 42, the fluid introduction line passing through the side port 15 or other opening of the holding tank 14 and in fluid communication with the elongate housing 16. The system 10 may also include a storage vessel 46 for storing the second fluid 32, the storage vessel 46 in fluid communication with the elongate housing 16 via the fluid introduction line 40.

In use, introduction of the second fluid 32 into the elongate housing 16 of the system 10 via the fluid introduction line 40 creates the flow rate sufficient to rotate both the primary 22 and the at least one secondary 44 rotor assemblies, thereby providing a force sufficient for the generator 38 to generate electricity. In one embodiment, the flow results from the less dense second fluid 32 mixing with and moving upward through the more dense first fluid 30. This upward movement of the second fluid 32 also draws the denser first fluid 30 upward, thereby generating an upward flow of both the first fluid 30 and the second fluid 32. As the first fluid 30 reaches the top of the elongate housing 16, it separates from the second fluid 32 and travels downward through the holding tank 14, thereby creating a downward flow sufficient for rotating the at least one secondary rotor assembly 44.

As mentioned above, and with continued reference to FIGS. 1, 2 and 3, fluid flow is created when a second fluid 32 is introduced into the first fluid 30. In the embodiments shown in FIGS. 1, 2 and 3, the second fluid 32 is less dense than the first fluid 30. For a more efficient application of the energy recovery system 10, the second fluid 32 is introduced at the bottom end of the elongated housing 16 through a fluid introduction line 40. The fluid introduction line 40 may be optionally provided with a dispersant nozzle 42 to assist in ensuring the introduction of the second fluid 32 is broadly applied within the elongated housing 16. As described, when the second fluid 32 is introduced into the first fluid 30, the second fluid 32, along with the first fluid 30, moves in an upward direction and applies force against the at least one blade 28 of the rotary assembly 22, causing the shaft 26 to turn to create electricity at the generator 38. Thus, the potential energy stored in the storage vessel is converted to kinetic energy. In the embodiment shown in FIGS. 1, 2 and 3, five separate turbine blade assemblies are shown. However, as few as one turbine blade assembly may be used or several more than five turbine blade assemblies may be used to capture the flow generated in the elongated housing 16.

While the first fluid 30 is preferably a denser fluid than the second fluid 32, it is feasible to have a reverse flow within the elongated housing 16 when the first fluid 30 is less dense than the second fluid 32 and the second fluid 32 is introduced into the elongated housing 16 through the top end. This reverse flow may be necessitated by the fluids available to the energy recovery system which would make a reverse flow embodiment the most efficient means to capture the available energy. An example might be an alcohol or oil separation chamber requiring denser fluids to sink into a lower part of a holding chamber. Or alternatively, the energy recovery system may require cleaning or maintenance fluids to be introduced that would temporarily reverse the fluid flow. Thus, the energy recovery system is not limited to flow in the upward direction in the elongated housing.

From a practical perspective, the two fluids that will most commonly be employed when using the energy recovery system are water as the first fluid and air as the second fluid. Air can be held in large storage tanks, vessels, or systems at high pressures. The stored air can then be introduced as the second fluid as previously described. Air rises into and through the elongated housing creating the desired flow. Thus, closed systems may not be the only practical embodiment as open systems might also be a viable option. FIG. 3 illustrates the energy recovery system in the open system where the open system is disclosed and the first fluid is represented by a body of a liquid fluid 48.

The open system embodiment of the energy recovery system can take advantage of circumstances in which air, gas or any other liquid is introduced into a body of water, including that found in association with fish hatcheries, waste treatment plants, and other similar systems. Furthermore, since compressed air might be simply captured by large windmills 50 in the open water, it is feasible to provide storage and recovery in nearby operation facilities. Optionally, the storage and recovery might be done directly on the water where the open system could be employed.

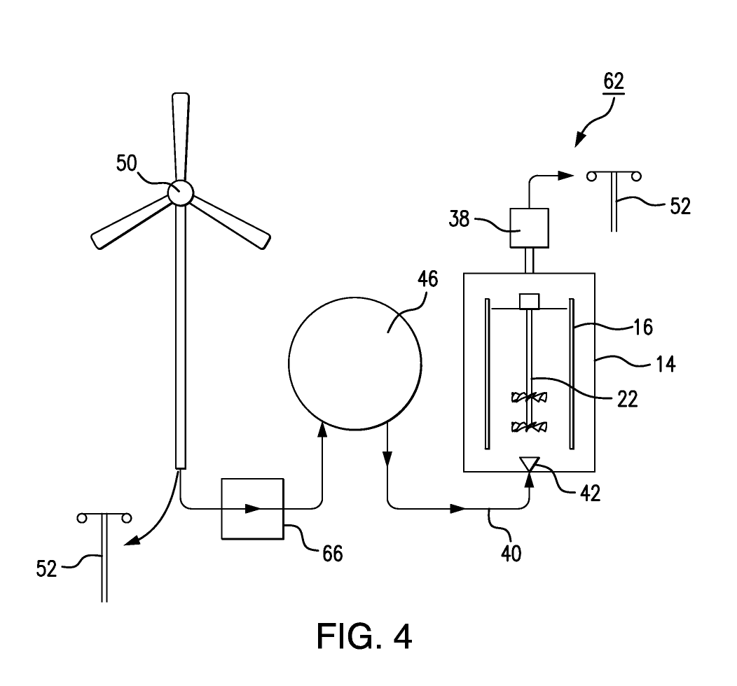

Referring now to FIG. 4, the energy recovery system 10 in operation with a larger electrical power system 62 is illustrated. The capturing and storing of gas or liquid can be done with a windmill 50 as shown in FIG. 4 or by other fluid capturing mechanisms such as a gas captured when burning hydrocarbons or waste, water run-off from dams, drainage or waterfalls, or other available systems. Optional storage of the fluid can be provided by storage vessels 46 or naturally present underground chambers. This optional storage is represented by a fluid storage vessel 46 found in FIG. 4. When electrical energy is needed, the second fluid in the fluid storage vessel 46 is released into the energy recovery system and electricity is generated. A power grid or other electrical infrastructure 52 is then used to transport the electrical energy to a population or to where there is a demand for electrical energy.

With continued reference to FIG. 4, one embodiment of a system 62 for generating electricity during periods of high and low energy demand comprises a windmill 50 for generating electrical power from wind, the generated electrical power being delivered to a power grid 52, the windmill 50 generating excess electrical power during the periods of low energy demand.

The system 62 also includes an air compressor 66 for generating compressed air, the air compressor 66 in electrical communication with the windmill 50, whereby the windmill 50 supplies electrical power to the air compressor during periods of low energy demand. A storage vessel 46 in fluid communication with the air compressor 66 is provided, the storage vessel 46 storing the compressed air generated by the air compressor 66.

Also provided is a tank 14 with upper and lower ends and an interior area, a housing 16 with upper and lower ends and an interior area, the housing 16 positioned within the interior area of the tank 14, the housing 16 and the tank 14 being in fluid communication with one another. A first fluid such as a volume of water is positioned within the interior areas of both the tank 14 and the housing 16.

With continued reference to FIG. 4, the system 62 includes a rotor assembly 22 positioned within the interior area of the housing 16, the rotor assembly 22 adapted to generate electrical power when rotated. A fluid line 40 and nozzle 42 fluidly interconnect the storage vessel 46 to the lower end of the housing 16, whereby compressed air from the storage vessel 46 is delivered via the fluid line 40 and nozzle 42 upwardly through the interior area of the housing 16 to mix with the water and to drive the rotor assembly 22 and deliver power to the power grid 52 during periods of high energy demand.

In use, and with continued reference to the embodiment illustrated in FIG. 4, planetary winds drive the rotation of a windmill 50. The windmill 50 in turn drives a turbine (not shown) and/or a generator (not shown), which generates electricity. During periods of peak electrical energy demand, the electricity generated is delivered directly to a power grid 52 for consumption by a population. During periods of lesser electrical energy demand, the electricity generated may be used to power an air compressor 66 operably connected to a compressed air storage vessel 46, thereby storing the energy generated by rotation of the windmill 50 as compressed air (i.e. a second fluid). When more energy is needed, the compressed air is released from the storage vessel 46 and introduced into the elongate housing 16 via the fluid introduction line 40 and the nozzle 42. The compressed air travels upward through the first fluid positioned in the elongate housing and the tank 14, thereby creating an upward flow sufficient for driving the rotation of the rotor assembly 22. The rotation of the rotor assembly 22 drives the generation of electricity by the generator 38, which is subsequently delivered via the power grid 52 to a population for consumption.

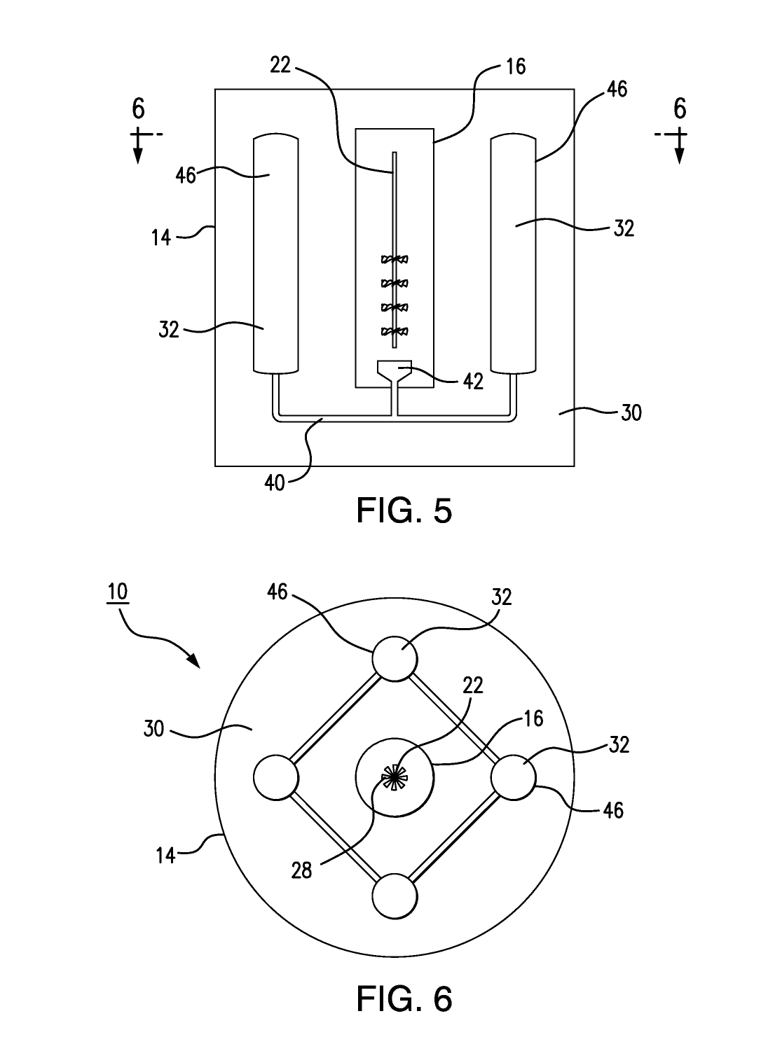

With reference to FIGS. 5 and 6, an alternative embodiment of the present invention includes at least one storage vessel 46 disposed within a holding tank 14. The at least one storage vessel may be arranged circumferentially about an interior perimeter of a generally cylindrical holding tank. This embodiment further includes an elongated housing with a primary rotor assembly 22 substantially as described above. The elongated housing may be positioned central to the at least one storage vessel. In this alternative embodiment, the system of the present invention is essentially self-contained for simplified storage, transport, and installation.

With continued reference to FIGS. 5 and 6, it will be appreciated by one of ordinary skill in the art that the increased pressure within the storage vessels upon storage of the second fluid will result in an increase in the temperature of the storage vessel and the surrounding first fluid. This increased temperature is a phenomenon quantifiable by the ideal gas law, the equation for which is pV=nRT, where p is the absolute pressure of the gas, V is the volume of the gas, n is the amount of substance of gas (measured in moles), T is the absolute temperature of the gas an R is the ideal gas constant. Thus, it is envisioned that the energy resulting from the increasing temperature of the first fluid may be subsequently captured and utilized to drive another related energy conversion device of system, such as a heat exchanger and the like. For example, the increase in temperature could reduce or eliminate the need for heating of the gas to prevent icing or freezing of the system during operation. Conversely, it will be appreciated by one of ordinary skill in the art that the release of the second fluid from the storage vessels will decrease the temperature of the vessel and the surrounding first fluid. This decrease in temperature may also be harnessed as desired.

Also envisioned to be within the scope of the present invention is the recapturing of the second fluid 32 for reuse or recycling after passage through the housing 16. For example, an embodiment of the system utilizing compressed air as the second fluid 32 may further include a means for capturing the compressed air from the system, such as a device for capturing the air released from an exhaust vent disposed within the suspension cap 36. Further, embodiments using an oil as the second fluid 32 may further include a skimming device for skimming the oil from the top of the housing 16 or tank 14 after it passes upward through the housing 16.

Further, the system described herein may be used primarily as a water circulation device, wherein electricity may be generated as desired.

Although this disclosure has been described in terms of certain embodiments and generally associated methods, alterations and permutations of these embodiments and methods will be apparent to those skilled in the art. Accordingly, the above description of example embodiments does not constrain this disclosure. Other changes, substitutions, and alterations are also possible without departing from the spirit and scope of this disclosure.

What is claimed is:

1. A system (10) for generating electricity, the system comprising:
a first fluid (30) having a first density;
a second fluid (32) having a second density, the first density being greater than the second density;
a holding tank (14), the holding tank (14) being generally cylindrical and including a side port (15) and a top opening (17), the first fluid (30) positioned within the holding tank (14);
a cylindrical elongate housing (16) having an interior surface, an exterior surface, an interior area, and first and second open ends, the elongate housing (16) disposed within and in fluid communication with the holding tank (14), the interior area receiving the first (30) and second fluids (32), the elongate housing (16) adapted for channeling the second fluid (32) through the first fluid (30) and including at least one stator (54) integral with the interior surface for increasing a flow rate therethrough;
a primary (22) and at least one secondary (44) rotor assembly, the primary rotor assembly (22) rotatably secured within the elongate housing (16) and the first (30) and second (32) fluids, the at least one secondary rotor assembly (44) rotatably secured within the holding tank (14) and within the first fluid (30), each rotor assembly further comprising a turbine (24) including a shaft (26) and at least one blade (28);
a suspension cap (36) for sealing the top opening of the holding tank (14), the suspension cap (36) fixedly secured to the elongate housing (16) by at least one bracket (56);
at least one generator (38) fixedly secured to the suspension cap (36), the at least one generator (38) operably connected to the primary (22) and at least one secondary (44) rotor assemblies;
a fluid introduction line (40) including a dispersant nozzle (42), the fluid introduction line (40) passing through the side port (15) of the holding tank (14) and in fluid communication with the elongate housing (16); and
a storage vessel (46) for storing the second fluid (32), the storage vessel (46) in fluid communication with the elongate housing (16) via the fluid introduction line (40);
wherein introduction of the second fluid (32) into the elongate housing (16) via the fluid introduction line (40) results in a counter-current flow of the first (30) and second (32) fluids between the elongate housing (16) and the holding tank (14) and rotation of both the primary (22) and the at least one secondary (44) rotor assemblies, thereby providing a force sufficient for the generator to generate electricity.

2. A system for generating electricity, the system comprising:
a first fluid (30) having a first density;
a second fluid (32) having a second density, wherein the second density is dissimilar to the first density;
an elongate housing (16) in fluid communication with the first fluid (30);
a rotor assembly (22) rotatably secured within the elongate housing (16), the rotor assembly (22) further comprising a turbine (24) including a shaft (26) and at least one blade (28);
a generator (38) operably connected to the rotor assembly (22);
at least one fluid introduction line (40) in fluid communication with the elongate housing (16); and
at least one storage vessel (46) for storing the second fluid (32), the at least one storage vessel (46) in fluid communication with the elongate housing (16) via the at least one fluid introduction line (40);
wherein introduction of the second fluid (32) into the elongate housing (16) drives a rotation of the rotor assembly (22), thereby providing a force sufficient for the generator (38) to generate electricity.

3. The system as described in claim 2, wherein the elongate housing (16) is disposed within the first fluid (30).

4. The system as described in claim 3 further comprising a holding tank (14) for containing the first fluid (30), the holding tank (14) including a top opening (17).

5. The system as described in claim 4 further comprising a suspension cap (36) for sealing the top opening (17) of the holding tank (14).

6. The system as described in claim 5, wherein the elongate housing (16) is fixedly secured to the suspension cap (36).

7. The system as described in claim 6, wherein the generator (38) is disposed within the suspension cap (36).

8. The system as described in claim 7, wherein the at least one storage vessel (46) is disposed within the holding tank (14).

9. The system as described in claim 8 further comprising at least one secondary rotor assembly (44) rotatably secured within the holding tank (14), the at least one secondary rotor assembly (44) operably connected to at least one generator (38) and further comprising a turbine (24) including a shaft (26) and at least one blade (28).

10. The system as described in claim 2, wherein the elongate housing (16) is generally cylindrical, and wherein the elongate housing (16) includes an interior surface, an exterior surface, and first and second open ends, the elongate housing adapted for channeling the second fluid (32) through the first fluid (30).

11. The system as described in claim 10, wherein the elongate housing (16) includes at least one stator (54) integral with the interior surface for increasing a flow rate therethrough.

12. The system as described in claim 2, wherein the first fluid (30) is substantially liquid water.

13. The system as described in claim 2, wherein the second fluid (32) is a compressed gas.

14. The system as described in claim 2, further comprising a windmill (50) operable to provide energy sufficient to compress the second fluid (32) within the storage vessel (46).

15. The system as described in claim 2, the system further in electrical communication with an existing electrical infrastructure (52), whereby the electricity generated by the system is delivered to a population.

16. A system (62) for generating electricity during periods of high and low energy demand, the system comprising:
a windmill (50) for generating electrical power from wind, the generated electrical power being delivered to a power grid (52), the windmill (50) generating excess electrical power during the periods of low energy demand;
an air compressor (66) for generating compressed air, the air compressor (66) in electrical communication with the windmill (50), whereby the windmill (50) supplies electrical power to the air compressor during periods of low energy demand;
a storage vessel (46) in fluid communication with the air compressor (66), the storage vessel (46) storing the compressed air generated by the air compressor (66);
a tank (14) with upper and lower ends and an interior area, a housing (16) with upper and lower ends and an interior area, the housing (16) positioned within the interior area of the tank (14), the housing (16) and the tank (14) being in fluid communication with one another, a volume of water positioned within the interior areas of both the tank (14) and the housing (16);
a rotor assembly (22) positioned within the interior area of the housing (16), the rotor assembly (22) adapted to generate electrical power when rotated;
a fluid line (40) and nozzle (42) fluidly interconnecting the storage vessel (46) to the lower end of the housing (16), whereby compressed air from the storage vessel (46) is delivered via the fluid line (40) and nozzle (42) upwardly through the interior area of the housing (16) to mix with the volume of water and to drive the rotor assembly (22) and deliver power to the power grid (52) during periods of high energy demand.

17. The system as described in claim 16, further comprising a suspension cap (36) for sealing the upper end of the tank.

18. The system as described in claim 17 wherein the housing (16) is fixedly connected to the suspension cap (36), thereby suspending the housing (16) within the tank (14).

19. The system as described in claim 17 further comprising a generator (38) housed within the suspension cap (36), the generator (38) operably connected to the rotor assembly (22) for generating electrical power.

20. The system as described in claim 17, wherein the suspension cap (36) further comprises an exhaust vent for releasing the compressed air from the tank (14).
